(19) United States
(12) Patent Application Publication
(10) Pub. No.: US 2007/0192344 A1
(43) Pub. Date: Aug. 16, 2007

(54) THREATS AND COUNTERMEASURES SCHEMA

(75) Inventors: John D. Meier, Bellevue, WA (US); Srinath Vasireddy, Issaquah, WA (US); Michael Dunner, Renton, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/382,857

(22) Filed: May 11, 2006

Related U.S. Application Data
(63) Continuation-in-part of application No. 11/321,153, filed on Dec. 29, 2005.

(51) Int. Cl. G06F 7/00

(52) U.S. Cl. 707/100

(57) ABSTRACT

An threats and countermeasures schema that can incorporate expertise into an application engineering activity is provided. For example, a threats and countermeasures schema can be applied to a threat modeling component to converge knowledge into the activity by identifying categories, vulnerabilities, attacks and countermeasures based upon an application type, user objective, etc. The novel threats and countermeasures schema can create a common framework that converges knowledge with respect to any application engineering activity (e.g. threat modeling). For example, the schema can include lists of threats and attacks that can be acted upon. As well, the framework can include a list of novel countermeasures based upon the attacks. Additionally, a context precision mechanism can be employed to automatically and/or dynamically determine a context of an application environment. This context can be used to automatically generate an appropriate schema based upon the determined application type.

### CROSS-REFERENCE TO RELATED APPLICATIONS

This application is a Continuation-in-Part of pending U.S. patent application Ser. No. 11/321,153 entitled “INFORMATION MODELS AND THE APPLICATION LIFE CYCLE” filed on Dec. 29, 2005. Additionally, this application is related to pending U.S. patent applications Ser. No. 11/321,425 entitled “SECURITY MODELING AND THE APPLICATION LIFE CYCLE” and filed Dec. 29, 2005, Ser. No. 11/321,818 entitled “PERFORMANCE MODELING AND THE APPLICATION LIFE CYCLE” filed on Dec. 29, 2005, Ser. No. 11/353,821 entitled “WEB APPLICATION SECURITY FRAME” filed on Feb. 14, 2006, and Ser. No. 11/363,142 entitled “SERVER SECURITY SCHEMA” filed on Feb. 27, 2006. The entireties of the above-noted applications are incorporated by reference herein.

### BACKGROUND

Analysis of software systems has proven to be extremely useful to development requirements and to the design of systems. As such, it can be particularly advantageous to incorporate security engineering and analysis into the software development life cycle from the beginning stage of design. Conventionally, the application life cycle lacks security engineering and analysis thereby prompting retroactive measures to address identified issues.

Today, when developing an application, it is oftentimes difficult to predict how the application will react under real-world conditions. In other words, it is difficult to predict security vulnerabilities of an application prior to and during development and/or before completion. Frequently, upon completion, a developer will have to modify the application in order to adhere to real-world conditions and threats of attacks. This modification can consume many hours of programming time and delay application deployment—each of which is very expensive.

Traditionally, designing for application security is oftentimes random and does not produce effective results. As a result, applications and data associated therewith are left vulnerable to threats and uninvited attacks. In most cases, the typical software practitioner lacks the expertise to effectively predict vulnerabilities and associated attacks.

While many threats and attacks can be estimated with some crude level of certainty, others cannot. For those security criterions that can be estimated prior to development, this estimate most often requires a great amount of research and guesswork in order to most accurately determine the criterion. The conventional guesswork approach of security analysis is not based upon any founded benchmark. As well, these conventional approaches are not effective or systematic in any way.

In accordance with traditional application life cycle development, it is currently not possible to proactively (and accurately) address security issues from the beginning to the end of the life cycle. To the contrary, developers often find themselves addressing security and performance issues after the fact—after development is complete. This retroactive modeling approach is extremely costly and time consuming to the application life cycle.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a threats and countermeasures schema that can leverage expertise to organize principles, patterns and practices and make vulnerabilities actionable. In other aspects, the threats and countermeasures schema can leverage expertise into a variety of application life cycle engineering activities. More particularly, the novel threats and countermeasures schema can converge knowledge into an engineering activity by identifying categories, vulnerabilities, attacks and countermeasures associated with an application type.

Effectively, the novel threats and countermeasures schema can create a common framework that converges knowledge and expertise with respect to a particular application engineering activity (e.g., threat modeling). For example, the framework can include lists of threats that can be acted upon. Similarly, the framework can include a list of attacks that can be acted upon. Still further, the framework can include a list of countermeasures based upon the attacks. In disparate aspects, the schema can be organized against known application vulnerability categories and therefore can be actionable from a developer's standpoint, from a code analysis standpoint and from an architect's standpoint.

In still another aspect, a context precision mechanism can be employed to automatically and/or dynamically determine a context of an application environment. In accordance therewith, threats and countermeasures schema can be established based at least in part upon the context. Essentially, the context precision concept can be described as a novel tool that can clarify guidance and product design by automatically defining a set of categories that facilitates highly relevant, highly specific guidance and actions.

In disparate particular aspects, dimensions of the context precision mechanism can be directed to application types, scenarios, project types, life cycles, etc. Accordingly, the context precision component can evaluate an application environment to determine the application type, for example, is it a web application, web service, a component, a framework, operating system, etc? Using these dimensions, very specific guidance can be generated and embedded within the novel threats and countermeasures schema.

Yet another aspect of the innovation employs machine learning and/or reasoning (MLR) techniques that infer an action that a user desires to be automatically performed. More particularly, an MLR component can be provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates generating and employing threats and countermeasures schema in accordance with an aspect of the innovation.

FIG. 2 illustrates a system that employs threats and countermeasures schema having multiple category, vulnerability, attack and countermeasure identifiers in accordance with an aspect of the innovation.

FIG. 3 illustrates a list of activities of a security engineering system in accordance with the novel innovation.

FIG. 4 illustrates an aspect that employs a threats and countermeasures schema in accordance with an input validation category.

FIG. 5 illustrates an aspect that employs a threats and countermeasures schema in accordance with an authentication category.

FIG. 6 illustrates a system that employs a context precision component that analyzes an application in accordance with an aspect of the innovation.

FIG. 7 illustrates an architecture including a machine learning and reasoning-based component that can automate functionality in accordance with an aspect of the novel innovation.

FIG. 8 illustrates an exemplary flow chart of procedures that facilitate determining a context, generating a schema and applying the schema to an engineering activity in accordance with an aspect of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

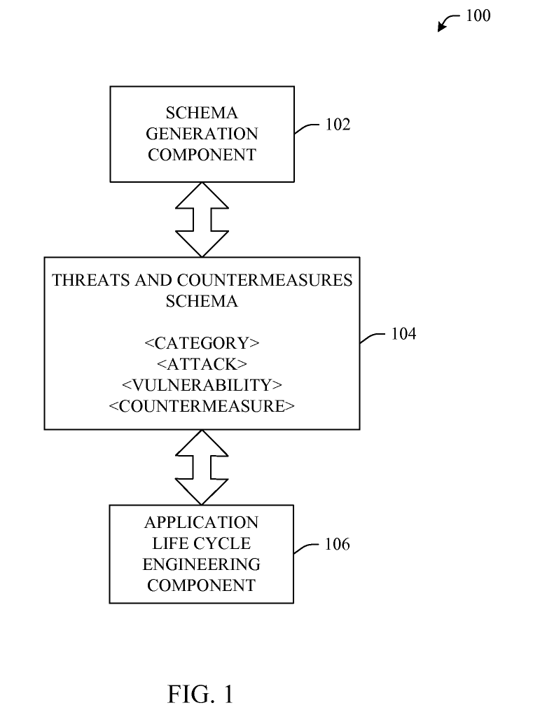

Referring initially to the figures, FIG. 1 illustrates a system 100 that facilitates configuring and providing a threats and countermeasures schema in accordance with an aspect of the innovation. Generally, system 100 includes a schema generation component 102 that facilitates generation of a threats and countermeasures schema component 104. The schema generation component 104 can enable identification of specific factors (e.g. categories, vulnerabilities, threats/attacks and counter measures) to be defined, formatted into the threats and countermeasures schema component 104 and input into an application life cycle component 106.

Although the examples described herein are directed to employing the novel schema in connection with life cycle engineering activities, it is to be understood that the novel schema can make vulnerabilities actionable by organizing principles, patterns and practices into a novel schema format. Effectively, knowledge and expertise can be leveraged into the novel schema thereby enabling formulating and/or identifying actionable vulnerabilities.

As will be better understood upon a review of the figures that follow, the threats and countermeasures schema 104 can be of the form as follows:

<CATEGORY>
<ATTACK>
<VULNERABILITY>
<COUNTERMEASURE>

Following are a list of questions that add perspective to each of a “threat category,” “attack,” “vulnerability,” and “countermeasure.” The questions are included to further explain the notion of “threat category,” “attack,” “vulnerability,” and “countermeasure.” A “threat category” addresses the question, “what is the negative effect/outcome?” Similarly, an “attack” addresses, “what is the list of attacks used to realize the threat?” A “vulnerability” addresses the question of “what are the weaknesses that allow the threats to occur or allow attacks?” Finally, a “countermeasure” addresses the question, “what are the principle-based approaches that can be used to either close the vulnerability or reduce the impact of negative consequences?”

By way of example, it will be understood that the novel threats and countermeasures schema component 104 can enable a user to incorporate and leverage security expertise into an application life cycle. The novel functionality and advantages thereof will be better understood upon a review of the figures that follow.

In one aspect, the threats and countermeasures schema 104 is a pattern-based schema that defines a set of security-related categories specifically related to the type of application that is being designed. Most often, the categories represent areas where security issues are most often made and/or overlooked. As will be understood upon a review of the figures that follow, the threats and countermeasures schema component 104 can be employed to leverage expertise not shared by the common user. In other words, the threats and countermeasures component 104 can incorporate categories, vulnerabilities, threats/attacks and countermeasures which have been identified by extremely experienced developers through research and testing. This information can be incorporated into the application life cycle engineering component 106.

In one particular aspect, the threats and countermeasures schema component 104 can identify a set of application layer vulnerabilities and threats/attacks and defines countermeasures (e.g., remedies) that are appropriate to address each threat/attack. To this end, the novel threats and countermeasures schema component 104 can facilitate categorization of issues (e.g., vulnerabilities/threats) in preparation for performing life cycle engineering tasks such as threat and/or security modeling.

The innovation described herein can facilitate analysis of the application life cycle and more particularly, application security, from the perspective of vulnerabilities, threats, attacks and countermeasures associated therewith. The following terms are used throughout the description, the definitions of which are provided herein to assist in understanding various aspects of the subject innovation.

An “asset” refers to a resource of value such as the data in a database or a file system, or a system resource. In another example, an asset might be an intangible resource or value such as a company's reputation.

A “threat” refers to an undesired event or a potential occurrence—malicious or otherwise—that may harm or compromise an asset.

A “vulnerability” refers to a weakness that makes an exploit (e.g., attack) possible. Vulnerabilities can include operational practices.

An “attack” (or “exploit”) refers to an action taken that utilizes one or more vulnerabilities to realize a threat.

A “countermeasure” refers to a safeguard that addresses a threat and mitigates risk. However, a countermeasure does not always directly address threats. Rather, a countermeasure addresses the factors that define threats. For example, a countermeasure can range from improving application design, or improving code, to improving an operational practice.

As described above, the threats and countermeasures schema component 104 of the subject innovation can identify a set of common application and code-level threats, and the recommended countermeasures to address each one. Although this description does not contain an exhaustive list of threats, attacks, vulnerabilities and/or countermeasures, it is to be understood that it does highlight many of the top items. With this information and knowledge of how an attacker works, a user can identify additional threats. In other words, the novel threats and countermeasures schema component 104 can enable a user to identify vulnerabilities and threats that are most likely to impact an application throughout the application life cycle.

While there are many variations of specific attacks and attack techniques, it can be particularly useful to view threats in terms of what the attacker is trying to achieve. In other words, focus can be shifted from the identification of every specific attack to focusing on the end results of possible attacks. Threats faced by the application can be categorized based on the goals and purposes of the attacks. A working knowledge of these categories of threats can help organize a security strategy so that preparation can be made with respect to responses to threats.

In one aspect particular categories of threat types can be employed. For example, STRIDE is an acronym that can be used to categorize different threat types. More particularly, STRIDE is an acronym for the following:

“Spoofing” refers to an act of attempting to gain access to a system by using a false identity. This can be accomplished using stolen user credentials or a false IP address. After the attacker successfully gains access as a legitimate user or host, elevation of privileges or abuse using authorization can begin.

“Tampering” is the unauthorized modification of data, for example as it flows over a network between two computers.

“Repudiation” is the ability of users (legitimate or otherwise) to deny that they performed specific actions or transactions. Without adequate auditing, repudiation attacks are often difficult to prove.

“Information disclosure” is the unwanted exposure of private data, for example, a user views the contents of a table or file he or she is not authorized to open, or monitors data passed in plaintext over a network. Some examples of information disclosure vulnerabilities include the use of hidden form fields, comments embedded in web pages that contain database connection strings and connection details, and weak exception handling that can lead to internal system level details being revealed to the client. Any of this information can be very useful to the attacker.

“Denial of service” is the process of making a system or application unavailable. For example, a denial of service attack might be accomplished by bombarding a server with requests to consume all available system resources or by passing it malformed input data that can crash an application process.

“Elevation of privilege” occurs when a user with limited privileges assumes the identity of a privileged user to gain privileged access to an application. For example, an attacker with limited privileges might elevate his or her privilege level to compromise and take control of a highly privileged and trusted process or account. Each of these STRIDE categories can include the threat categories described infra.

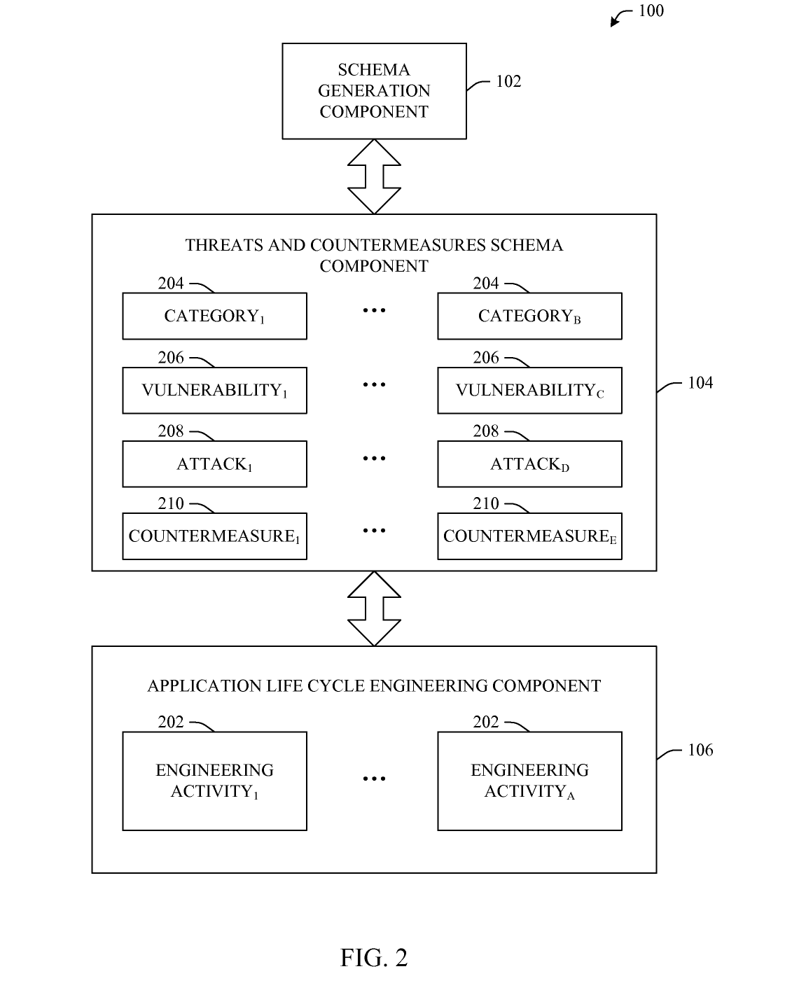

Referring now to FIG. 2, an alternative block diagram of system 100 is shown. More particularly, as illustrated, the application life cycle engineering component 106 can include 1 to A engineering activity components, where A is an integer. These 1 to A engineering activity components can be referred to individually or collectively as engineering activity components 202. In accordance with a particular aspect, a threat modeling activity can be employed which refers to an engineering mechanism that can identify threats, attacks, vulnerabilities and countermeasures in accordance with the application development life cycle.

Additionally, as shown, the threats and countermeasures schema component 104 can include 1 to B category components 204, 1 to C vulnerability components 206, 1 to D threat/attack components 208, and 1 to E countermeasure components 210, where B, C, D and E are integers. Each of these threats and countermeasures schema subcomponents (204, 206, 208, 210) will be better understood upon a review of the figures that follow.

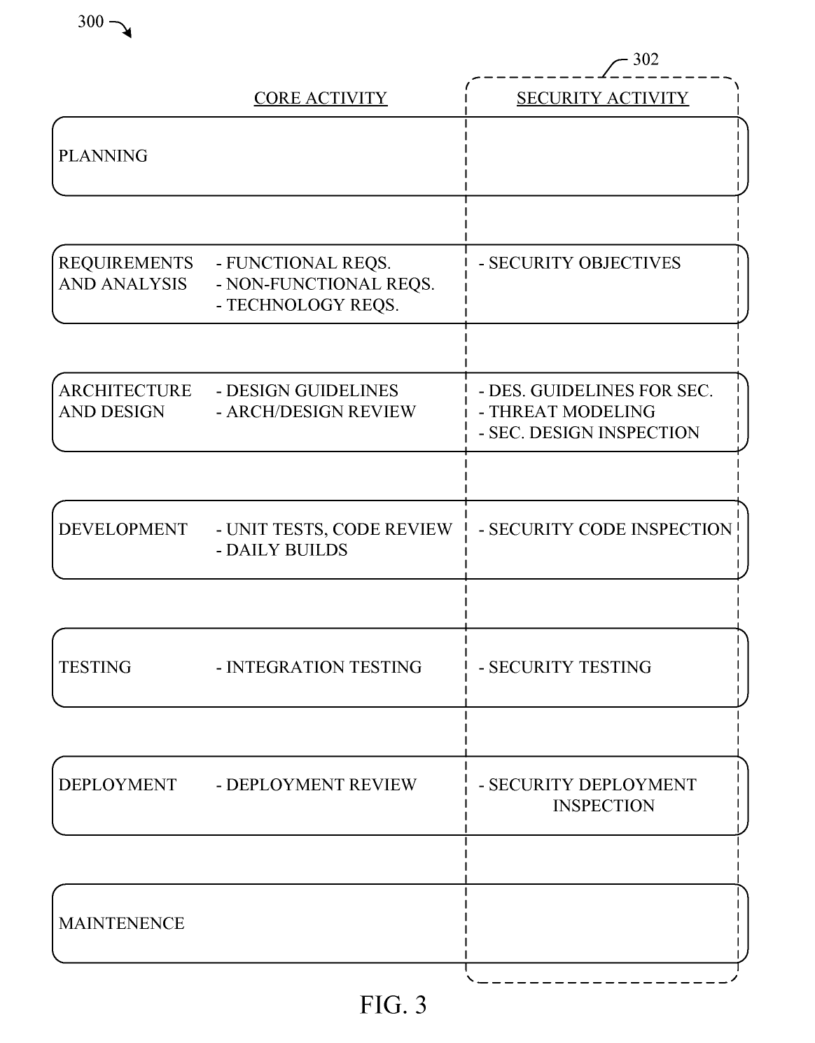

Referring again to the engineering activity components 202 and with reference to FIG. 3, for instance, as the example described herein is directed to a security scenario, in a security engineering environment, the novel threats and counter measure schema 104 can be employed in connection with a number of security engineering activities related to an application life cycle. As shown in FIG. 3, the security engineering life cycle can include a set of proven security-focused activities 302. Expertise can be incorporated into each of these activities through the use of the novel threats and countermeasures schema component 104 described herein.

It is to be understood and appreciated that the subject security engineering model of FIG. 3 can facilitate the ability to bake security into the application life cycle. In doing so, security focus can be added to the following common security engineering activities:
Identifying security objectives;
Design guidelines for security;
Threat modeling;
Architecture and design review for security;
Code review for security;
Security testing; and
Deployment review for security.

Below is an exemplary list of categories 204 in accordance with an aspect of the innovation. While the exemplary categories illustrate a particular grouping, it is to be understood the groupings can be organized in any manner without departing from the spirit and scope of the innovation and claims appended hereto in any way.

The following table summarizes categories 204 that can be represented within a threats and countermeasures schema 104 in accordance with aspects of the innovation. Additionally, the table below includes a description of each of the categories 204 in order to add perspective to the innovation.

| Category (204) | Description |
|---|---|
| Input and Data | How do you know that the input received by the application is |
| Validation | valid and safe? |
| | Should data be trusted from sources such as data bases and file |
| | shares? |
| | Input validation refers to how the application filters, scrubs, or rejects input |
| | before additional processing. |
| Authentication | Who are you? |
| | Authentication is the process where an entity proves the |
| | identity of another entity, typically through credentials, such as a user name |
| | and password. |
| Authorization | What can you do? |
| | Authorization is how the application provides access controls |
| | for resources and operations. |
| Configuration | Who does the application run as? |
| Management | Which databases does the application connect to? |
| | How is the application administered? |
| | How are these settings secured? |
| | Configuration management refers to how the application |
| | handles these operational issues. |
| Sensitive Data | How does the application handle sensitive data? |
| | Sensitive data refers to how the application handles any data |
| | that must be protected either in memory, over the network, or |
| | in persistent stores. |
| Session | How does the application handle and protect user sessions? |
| Management | A session refers to a series of related interactions between a user and the |
| | Web application. |
| Cryptography | How are you keeping secrets (confidentiality)? |
| | How are you tamper-proofing data or libraries (integrity)? |
| | How are you providing seeds for random values that must be |
| | cryptographically strong? |
| | Cryptography refers to how the application enforces |
| | confidentiality and integrity. |
| Exception | When a method call in the application fails, what does the |
| Management | application do? |
| | How much do you reveal? |
| | Do you return friendly error information to end users? |
| | Do you pass valuable exception information back to the caller? |
| | Does your application fail gracefully? |
| Auditing and | Who did what and when? |
| Logging | Auditing and logging refer to how the application records security-related |
| | events. |

The following table illustrates an exemplary list of vulnerabilities 206 that correspond to the aforementioned categories 204. Again, as mentioned above, this list is not intended to be exhaustive or limiting in any way. Other vulnerabilities exist and are to be included within the scope of this disclosure and claims appended hereto.

| Category (204) | Vulnerability (206) |
|---|---|
| Input and Data | Using non-validated input in a hypertext markup |
| Validation | language (HTML) output stream. |
| | Using non-validated input to generate queries (e.g., SQL |
| | queries). |
| | Using input file names, URLs, or user names for security |
| | decisions. |
| | Using application-only filters for malicious input. |
| | Looking for known bad patterns or input. |
| | Trusting data read from databases, file shares, and other |
| | network resources. |
| | Failing to validate input from all sources including |
| | cookies, query string parameters, HTTP headers, |
| | databases, and network resources. |
| Authentication | Using weak passwords. |
| | Storing clear text credentials in configuration files. |
| | Passing clear text credentials over the network. |
| | Permitting over-privileged accounts. |
| | Permitting prolonged session lifetime. |
| | Mixing personalization with authentication. |
| Authorization | Relying on a single gatekeeper. |
| | Failing to lock down system resources against application |
| | entities. |
| | Failing to limit database access to specified stored |
| | procedures. |
| | Using inadequate separation of privileges. |
| Configuration | Using insecure administration interfaces. |
| Management | Using insecure configuration stores. |
| | Storing clear text configuration data. |
| | Having too many administrators. |
| | Using over-privileged process accounts and service |
| | accounts. |
| Sensitive Data | Storing secrets when you do not need to. |
| | Storing secrets in code. |
| | Storing secrets in clear text. |
| | Passing sensitive data in clear text over networks. |
| Session | Passing session identifiers over unencrypted channels. |
| Management | Permitting prolonged session lifetime. |
| | Having insecure session state stores. |
| | Placing session identifiers in query strings. |
| Cryptography | Using custom cryptography. |
| | Using the wrong algorithm or a key size that is too small. |
| | Failing to secure encryption keys. |
| | Using the same key for a prolonged period of time. |
| | Distributing keys in an insecure manner. |
| Exception | Failing to use structured exception handling. |
| Management | Revealing too much information to the client. |
| Auditing and | Failing to audit failed logons. |
| Logging | Failing to secure audit files. |
| | Failing to audit across application tiers. |

One particularly useful method of analyzing application-level threats/attacks 208 is to organize them by category 204. The table below summarizes a set of threats/attacks 208 with reference to each category 204 identified above.

| Category (204) | Threats/Attacks (208) |
|---|---|
| Input and Data | Buffer overflow. |
| Validation | Cross-site scripting. |
| | SQL injection. |
| | Canonicalization. |
| | Query string manipulation. |
| | Cookie manipulation. |
| | HTTP header manipulation. |
| Authentication | Network eavesdropping. |
| | Brute force attacks. |
| | Dictionary attacks; |
| | Cookie replay attacks. |
| | Credential theft. |
| Authorization | Elevation of privilege. |
| | Disclosure of confidential data. |
| | Data tampering. |
| | Luring attacks. |
| Configuration | Unauthorized access to administration interfaces. |
| Management | Unauthorized access to configuration stores. |
| | Retrieval of clear text configuration data. |
| | Lack of individual accountability. |
| | Over-privileged process and service accounts. |
| Sensitive Data | Accessing sensitive data in storage. |
| | Accessing sensitive data in memory (including |
| | process dumps). |
| | Network eavesdropping. |
| | Information disclosure. |
| Session Management | Session hijacking. |
| | Session replay. |
| | Man in the middle attacks. |
| Cryptography | Loss of decryption keys. |
| | Encryption cracking. |
| Exception | Revealing sensitive system or application details. |
| management | Denial of service attacks. |
| Auditing and logging | User denies performing an operation. |
| | Attacker exploits an application without trace. |
| | Attacker covers his/her tracks. |

In accordance with the exemplary categories 204, vulnerabilities 206 and threats/attacks 208, the following table illustrates exemplary countermeasures 210 that can be included within the threats and countermeasures schema component 104.

| Category (204) | Countermeasures (210) |
|---|---|
| Input and Data | Do not trust input. |
| Validation | Validate input: length, range, format, and type. |
| | Constrain, reject, and sanitize input. |
| | Encode output. |
| Authentication | Use strong password policies. |
| | Do not store credential. |
| | Use authentication mechanisms that do not require clear |
| | text credentials to be passed over the network. |
| | Encrypt communication channels to secure |
| | authentication tokens. |
| | Use HTTPS only with forms authentication cookies. |
| | Separate anonymous from authenticated pages. |
| Authorization | Use least privilege accounts. |
| | Consider granularity of access. |
| | Enforce separation of privileges. |
| | Use multiple gatekeepers. |
| | Secure system resources against system identities. |
| Configuration | Use least privileged service accounts. |
| Management | Do not store credentials in clear text. |
| | Use strong authentication and authorization on |
| | administrative interfaces. |
| | Do not use the Local Security Authority (LSA). |
| | Avoid storing sensitive information in the web space. |
| | Use only local administration. |
| Sensitive Data | Do not store secrets in software. |
| | Encrypt sensitive data over the network. |
| | Secure the channel. |
| Session | Partition site by anonymous, identified, and |
| Management | authenticated users. |
| | Reduce session timeouts. |
| | Avoid storing sensitive data in session stores. |
| | Secure the channel to the session store. |
| | Authenticate and authorize access to the session store. |
| Cryptography | Do not develop and use proprietary algorithms (e.g., |
| | XOR is not encryption, use platform-provided |
| | cryptography). |
| | Avoid key management. |
| | Periodically change keys. |
| Exception | Use structured exception handling (e.g., use try/catch |
| management | blocks). |
| | Catch and wrap exceptions only if the operation adds |
| | value/information. |
| | Do not reveal sensitive system or application |
| | information. |
| | Do not log private data such as passwords. |
| Auditing and | Identify malicious behavior. |
| logging | Know your baseline (e.g., know what good traffic |
| | looks like). |
| | Use application instrumentation to expose behavior |
| | that can be monitored. |

Following is a list of exemplary countermeasures 210 with respect to more specific threats and/or attacks 208 in accordance with an aspect of the innovation. These more specific threats/attacks 208 correspond to the STRIDE acronym described supra. While this list includes specific countermeasures 210, it is to be appreciated that the list is not intended to be exhaustive and/or limiting in any way. As well, it is to be understood that other countermeasures 210 can exist to address each exemplary threat/attack 208 listed. These additional countermeasures 210 are to be included within the scope of this innovation and claims appended hereto. As such, these additional countermeasures 210 can be incorporated (e.g., embedded) into the threats and countermeasures component (104 of FIG. 1) without departing from the spirit and/or scope of the innovation and claims appended hereto.

| Threat/ | |
|---|---|
| attack (206) | Countermeasures (208) |
| Spoofing | Use strong authentication. |
| user identity | Do not store secrets (for example, passwords) in plaintext. |
| | Do not pass credentials in plaintext over the wire. |
| | Protect authentication cookies with Secure Sockets Layer |
| | (SSL). |
| Tampering | Use data hashing and signing. |
| with data | Use digital signatures. |
| | Use strong authorization. |
| | Use tamper-resistant protocols across communication links. |
| | Secure communication links with protocols that provide |
| | message integrity. |
| Repudiation | Create secure audit trails. |
| | Use digital signatures. |
| Information | Use strong authorization. |
| disclosure | Use strong encryption. |
| | Secure communication links with protocols that provide |
| | message confidentiality. |
| | Do not store secrets (for example, passwords) in plaintext. |
| Denial of | Use resource and bandwidth throttling techniques. |
| service | Validate and filter input. |
| Elevation | Follow the principle of least privilege and use least |
| of privilege | privileged service accounts to run processes and access |
| | resources. |

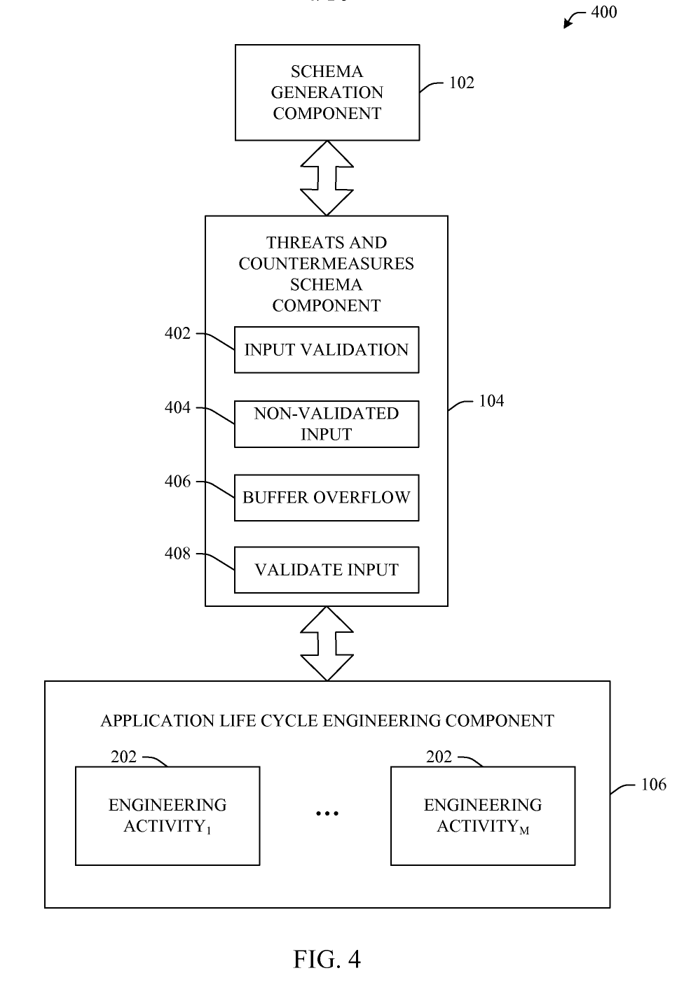

Referring now to FIG. 4, an alternative system 400 that facilitates establishing a novel threats and countermeasures schema 104 in accordance with an aspect of the innovation is shown. Generally, system 400 can include a schema generation component 102, a threats and countermeasures schema component 104 and an application life cycle engineering component 106.

As described supra, the threats and countermeasures schema 104 can include a category component 402, a vulnerability component 404, a threat/attack component 406 and a countermeasure component 408. In the specific example shown, the category 402 is an input validation category. Accordingly, the vulnerability (404), threat/attack (406) and countermeasure components (408) are non-validated input, buffer overflow and validate input respectively.

Although specific threats and countermeasure schema components 104 are shown, it is to be understood that other sub-components and information can be embedded within novel threats and countermeasures schema 104 without departing from the spirit and scope of the innovation described herein. In all, the novel threats and countermeasures schema component 104 enables a user to leverage expertise developed and embedded within the sub-components.

Continuing with the example of FIG. 4, input and data validation is a key category for potential security issues. This category can be employed if an attacker discovers that an application makes unfounded assumptions about the type, length, format, or range of input data. Accordingly, in these situations, the attacker can supply carefully crafted input that compromises the application.

When network and host level entry points are protected; the public interfaces exposed by the application become a primary source of attack. The input to the application is a means to both test the system and a way to execute code on an attacker's behalf. If the application blindly trusts input, the application may be vulnerable. Accordingly, the countermeasure (408) included within the novel threats and countermeasure schema 104 of FIG. 4 is “validate input.” Thus, security can be maintained.

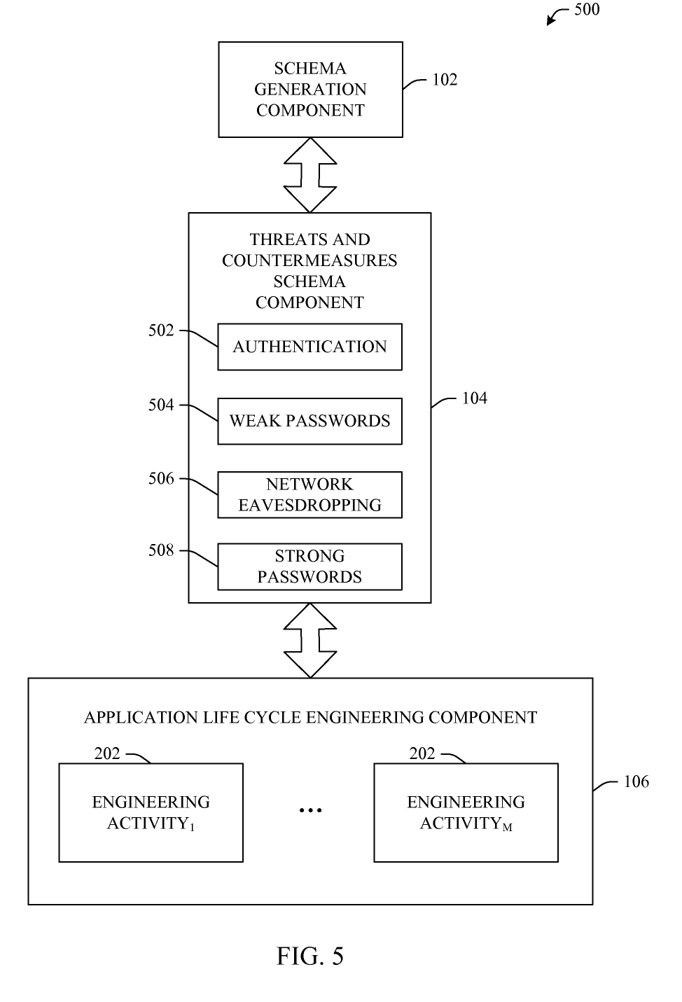

FIG. 5 illustrates an alternative system 500 that facilitates an alternative threats and countermeasures schema 104 in accordance with an aspect of the innovation. More particularly, the category 502 can be an authentication category whereas the vulnerability 504 can be the use of weak passwords. This particular vulnerability can lead to network eavesdropping attacks 506. To this end, strong passwords can be employed as a countermeasure 508 to combat such an attack. Depending on the system requirements, there are several available authentication mechanisms from which to choose. If the authentication mechanisms are not correctly chosen and implemented, they can expose vulnerabilities that attackers can exploit to gain access to your system.

Other examples of countermeasures to authentication attacks can include the following:

Encryption of credentials over the wire. It is particularly important to avoid sending plain-text credentials over the wire. If it is necessary to send credentials over the wire, they should be encrypted to help protect them if they are captured during a network sniffing attack.

Protect authentication tokens. It is particularly important to encrypt authentication tokens over the wire. A user should employ an encrypted channel (for example by using SSL) to prevent an attacker from sniffing authentication tokens and using them in cookie replay attacks.

Enforce strong password policies. It can be helpful to enforce password complexity requirement by requiring long passwords with a combination of upper case, lower case, numeric and special (for example punctuation) characters. This assists in mitigation of the threat posed by dictionary attacks. If possible, it can also be helpful to enforce automatic password expiry.

As well, a user should store password hashes instead of the passwords or encrypted passwords. If forms authentication is implemented, user passwords should not be stored if the sole purpose is to verify that the user knows the password value. Rather, it can be helpful to store a verifier in the form of a hash value and to re-compute the hash using the user-supplied value during the logon process. It is also prudent to avoid storing encrypted passwords because it raises key management issue. A user should combine password hashes with a salt value (a cryptographically strong random number) to mitigate the threat associated with brute force attacks and dictionary attacks.

Following is a discussion of other novel threats and countermeasures categories. It is to be understood that this list is not exhaustive and is to be considered in addition to those categories highlighted in the tables supra. Moreover, those skilled in the art will understand that other categories, and associated vulnerabilities, attacks and/or countermeasures, exist. These additional categories and sub-components are to be included within the novelty of leveraging expertise within the novel threats and countermeasures schema described herein.

With reference now to authorization, based upon user identity and role membership, authorization to a particular resource or service is either allowed or denied. Accordingly, vulnerabilities such as poor authorization control and poor or predictable session identifiers exist with respect to this category.

Attacks such as forceful browsing or session hijacking are possible in view of these vulnerabilities. As such, countermeasures can include applying an authorization control to every object that authorizes access based on the identity of the authenticated principle requesting access. As well, a user should employ strong random numbers for session identifiers (e.g. GUIDs).

Auditing and logging can be used to help detect suspicious activity such as footprinting or possible password cracking attempts before an exploit actually occurs. This auditing and logging category can also help deal with the threat of repudiation. It is to be understood that it can be increasingly more difficult for a user to deny performing an operation if a series of synchronized log entries on multiple servers indicate that the user performed a particular transaction. A countermeasure to prevent an auditing and logging attack can include disabling anonymous access and authenticating every principle.

Client side validation occurs when the server trusts the client to authenticate, authorize itself or validate data. The attack can occur when the attacker turns off this authentication and misrepresents the authentication or authorization state to the server. Client side validation is usually accomplished via scripts that run on the client machine. These scripts can either be blocked or altered by the client at will and are completely attacker controlled. To combat client side validation, a server should not trust the client to authenticate or authorize itself. As well, client side validation accomplished for performance reasons should be verified by the server.

With respect to communications security, vulnerabilities can include unsecure communication channels (e.g. lacking confidentiality protection). The following is a list of examples of attacks that can occur:
Denial of service
Information gathering
Network Eavesdropping
Session hijacking
Sniffing
Spoofing

To this end, countermeasures can include:
Utilize SSL or IPSec with encryption to establish a secure communication channel.
Configure routers to restrict their responses to footprinting requests.
Configure operating systems that host network software (for example, software firewalls) to prevent footprinting by disabling unused protocols and unnecessary ports.
Use strong physical security and proper segmenting of the network. This is the first step in preventing traffic from being collected locally.
Encrypt communication fully, including authentication credentials. This prevents sniffed packets from being usable to an attacker. SSL and IPSec (Internet Protocol Security) are examples of encryption solutions.
Filter incoming packets that appear to come from an internal IP address at the perimeter.
Filter outgoing packets that appear to originate from an invalid local IP address.
Use encrypted session negotiation.
Use encrypted communication channels.
Stay informed of platform patches to fix TCP/IP vulnerabilities, such as predictable packet sequences.
Apply the latest service packs.
Harden the TCP/IP stack by applying the appropriate registry settings to increase the size of the TCP connection queue, decrease the connection establishment period, and employ dynamic backlog mechanisms to ensure that the connection queue is never exhausted.
Use a network Intrusion Detection System (IDS) because these can automatically detect and respond to SYN attacks.

It is to be understood that the aforementioned information can be embedded within a novel threats and countermeasures schema component 104 thereby leveraging expertise into the application development life cycle. This novel approach of the threats and countermeasures schema enables a user to create a library of threats that becomes very actionable because it is possible to organize principles/patterns specifically around each dimension: threat, attack, vulnerability, and countermeasure.

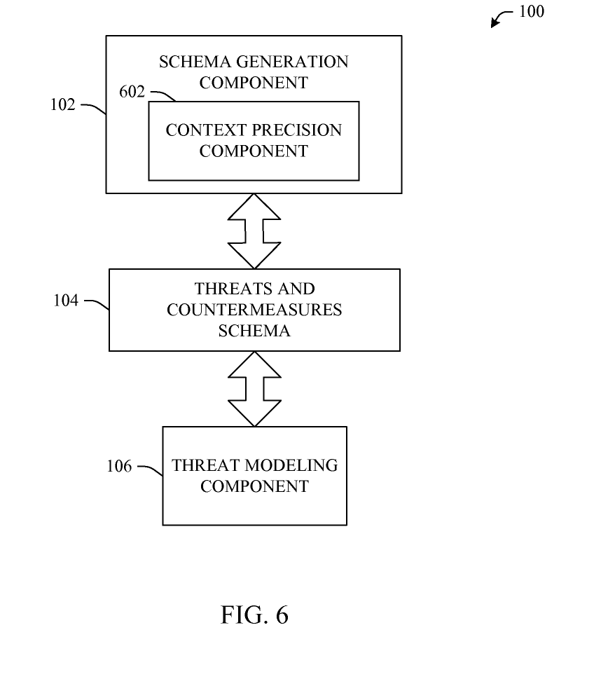

Turning now to FIG. 6, a system 600 that facilitates identification of an appropriate threats and countermeasures schema 104 is shown. More particularly, the schema generation component 102 can include a context precision component 602 which can automatically determine a specific application type thereby facilitating determination of an appropriate threats and countermeasures schema component 104 that matches the application type. As well, the threats and countermeasures schema component 104 can be matched to a user goal or set of goals.

The novel context precision component 602 is a tool that can clarify guidance and product design. In other words, the context precision component 602 can generate a set of categories 204 that facilitates highly relevant, highly specific guidance and actions in view of the application and/or user goal(s), etc. For example, one dimension can be application type, another dimension can be scenario, another dimension can be project type, and yet another dimension can be life cycle.

Accordingly, the context precision component 602 can determine a context of a particular application environment thereby facilitating automatic generation of an appropriate threats and countermeasures schema component 104. By way of further example, the context precision component 602 can be employed to determine if an environment contains a specific web application type, for example, e-commerce, digital rights management based application, etc. In still another aspect, the context precision component 602 can determine a particular application scenario, for example, Internet, intranet, etc.

Using these dimensions, very specific guidance can be generated and incorporated within the novel threats and countermeasures schema component 104. In all, the threats and countermeasures schema 104 is a pattern-based information model that defines a set of security-related categories specifically for the application type that is being designed. Frequently, these categories represent the areas where security mistakes are most often made and/or problems encountered. Patterns and practices security guidance includes context-specific security frames for each major application type.

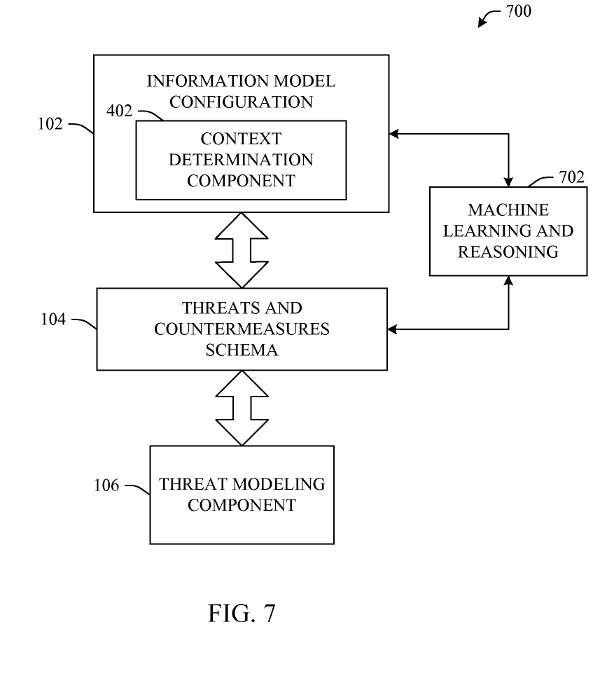

FIG. 7 illustrates a system 700 that employs a machine learning and reasoning component (MLR) (e.g. artificial intelligence (AI) component) 602 which facilitates automating one or more features in accordance with the subject innovation. The subject innovation (e.g., determining an application type, categories, vulnerabilities, attacks, countermeasures, etc.) can employ various MLR-based schemes for carrying out various aspects thereof. For example, a process for determining a threats, vulnerabilities and/or countermeasures can be facilitated via an automatic classifier system and process.

A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g. factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g. via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria threats, vulnerabilities and/or countermeasures.

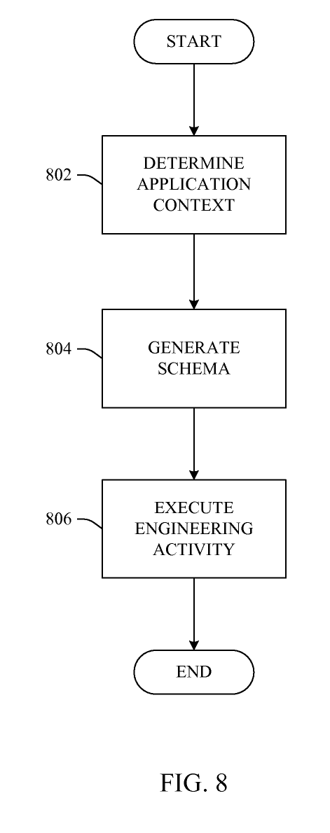

FIG. 8 illustrates a methodology of establishing threats and countermeasures schema in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 802, the context can be determined of an application and/or system. In other words, in one aspect, a context precision mechanism can be employed to analyze an application thereby establishing an application type, project type, scenario, life cycle type, etc. The gathered information can be employed in order to generate a threats and countermeasures schema at 804.

At 804, in one aspect of the innovation, a threats and countermeasures schema can be established that defines one or more categories, vulnerabilities, attacks and/or countermeasures. This threats and countermeasures schema can facilitate incorporating expertise into an engineering activity at 806. For example, the threats and countermeasures schema facilitates incorporating expertise into a security modeling activity. It is to be understood and appreciated that numerous threats and countermeasures schemas can be established which facilitate incorporating expertise into other engineering activities.

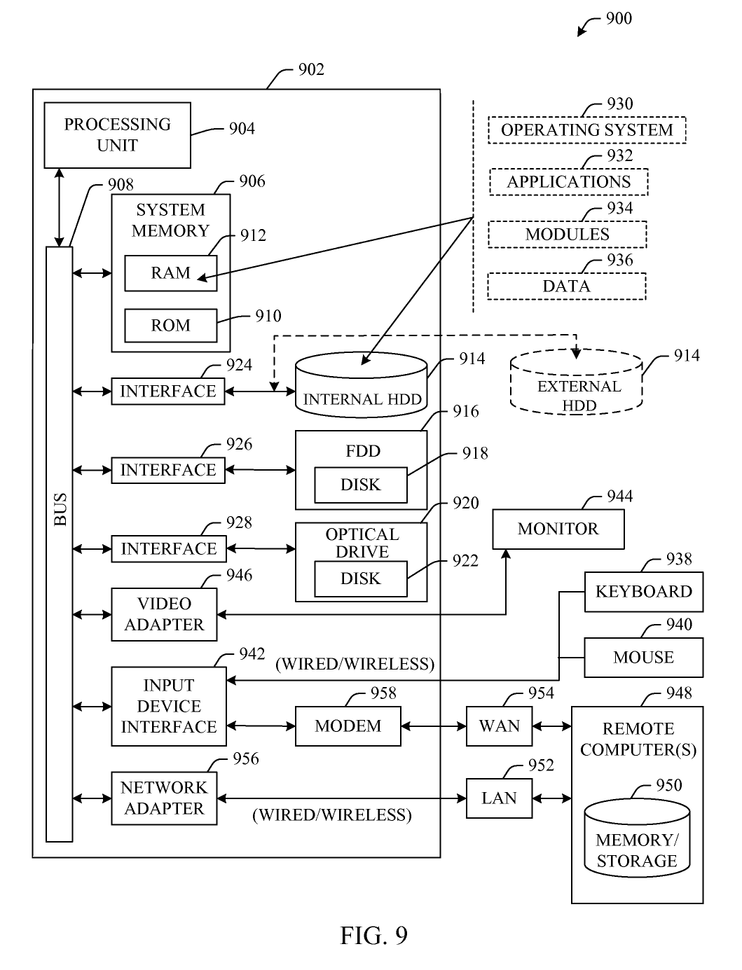

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g. a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

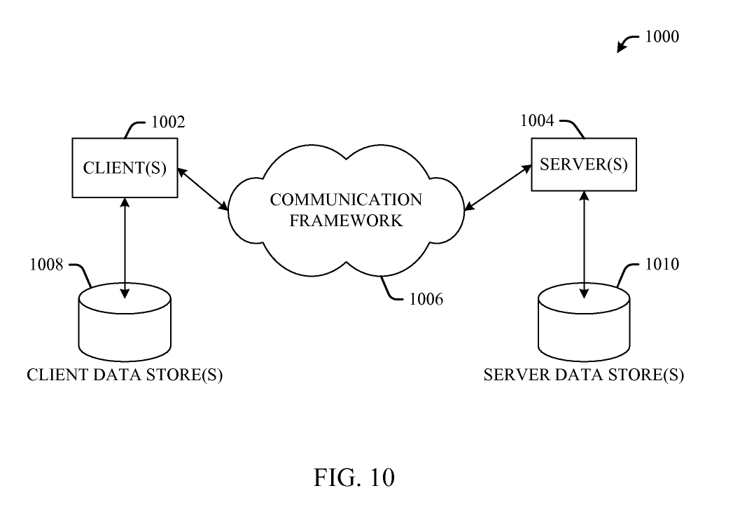

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g. threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates leveraging knowledge into development of an application, comprising:
an schema generation component that incorporates expertise into threats and countermeasures schema; and
an application engineering component that executes an engineering activity based at least in part upon the threats and countermeasures schema.

2. The system of claim 1, the threats and countermeasures schema comprises:
a category identifier;
a vulnerability identifier;
an attack identifier; and
a countermeasure identifier.

3. The system of claim 1, the engineering activity is at least one of a security objective definition, a threat modeling, a code inspection and a deployment inspection activity.

4. The system of claim 1, further comprising a context precision component that analyzes the application and establishes a context; the threats and countermeasures schema is based at least in part upon the context.

5. The system of claim 4, the context defines at least one of an application type, a project type, and a life cycle type.

6. The system of claim 1, the threats and countermeasures schema defines an input validation category.

7. The system of claim 6, the threats and countermeasures schema comprises a non-validated input vulnerability component, a buffer overflow attack component and an input validation countermeasure component.

8. The system of claim 1, the threats and countermeasures schema defines an authentication category.

9. The system of claim 8, the threats and countermeasures schema comprises a weak passwords vulnerability component, a network eavesdropping attack component and a strong passwords countermeasure component.

10. The system of claim 1, further comprising a machine learning and reasoning (MLR) component that infers an action that a user desires to be automatically performed.

11. A computer-implemented method of engineering an application, comprising:
generating a threats and countermeasures schema; and
executing an application engineering activity based at least in part upon the threats and countermeasures schema.

12. The computer-implemented method of claim 11, further comprising determining a context of the application and incorporating the context into the act of generating the threats and countermeasures schema.

13. The computer-implemented method of claim 12, the context includes at least one of an application type, a project type and a life cycle type.

14. The computer-implemented method of claim 11, the act of generating a threats and countermeasures schema comprises:
embedding a category identifier;
embedding a vulnerability identifier;
embedding an attack identifier; and
embedding a countermeasure identifier.

15. The computer-implemented method of claim 11, the threats and countermeasures schema defines at least one of an input and data validation system, an authentication system, an authorization system, an auditing and logging system, a client side validation system, a communications security system, a configuration management system, a cryptography system, an exception management system, a sensitive data system and a session management system.

16. A computer-executable system that facilitates leveraging knowledge into engineering of an application, comprising:
means for identifying a context of the application;
means for identifying a threats and countermeasures schema based at least in part upon the context; and
means for performing an application engineering activity based at least in part upon the threats and countermeasures schema.

17. The computer-executable system of claim 16, the threats and countermeasures schema includes a category, a vulnerability, an attack and a countermeasure based at least in part upon the context.

18. The computer-executable system of claim 17, the means for identifying the context is a context precision component.

19. The computer-executable system of claim 18, the engineering activity is a threat modeling activity.

20. The computer-executable system of claim 18, the category is at least one of an input and data validation system, an authentication system, an authorization system, an auditing and logging system, a client side validation system, a communications security system, a configuration management system, a cryptography system, an exception management system, a sensitive data system and a session management system.
